(19) United States
(12) Patent Application Publication
(10) Pub. No.: US 2019/0070936 A1
(43) Pub. Date: Mar. 7, 2019

(54) AIR DISCHARGE DEVICE

(71) Applicant: DENSO CORPORATION, Kariya-city, Aichi-pref. (JP)

(72) Inventors: Takeyuki OTSUKI, Kariya-city (JP); Yasuhiko NIIMI, Kariya-city (JP)

(21) Appl. No.: 16/081,050

(22) PCT Filed: Nov. 23, 2016
(86) PCT No.: PCT/JP2016/084685

§ 371 Date: Aug. 30, 2018

(30) Foreign Application Priority Data
Mar. 4, 2016 (JP) 2016-042449

(51) Int. Cl. B60H 1/34; F24F 13/14; F24F 13/08

(52) U.S. Cl. CPC B60H 1/3414; F24F 13/26; F24F 13/081; F24F 13/14

(57) ABSTRACT

An air discharge device includes a blowout port, a flow path forming portion that forms therein an air flow path, and an air flow deflecting member. The flow path forming portion includes a first wall, a second wall that faces the first wall, and a third wall and a fourth wall that connect the first wall with the second wall. A part of the first wall on the side of the blowout port forms a guide wall shaped such that a distance between the first wall and the second wall increases along a direction toward an air flow downstream side. At least one of the third wall or the fourth wall includes a separation shape portion configured to cause an air flow on the air flow downstream side of the air flow deflecting member to separate from at least one of the third wall or the fourth wall.

### CROSS REFERENCE TO RELATED APPLICATIONS

This application is based on Japanese Patent Application No. 2016-42449 filed on Mar. 4, 2016, the description of which is hereby incorporated by reference.

### TECHNICAL FIELD

The present disclosure relates to an air discharge device for discharging air.

### BACKGROUND ART

Patent Document 1 discloses an air discharge device that blows air from a blowout port while bending air along a guide wall by using the Coanda effect. Specifically, this air discharge device includes a blowout port for blowing out air to a target space, a flow path forming portion for forming therein an air flow path in communication with the air flow upstream side of the blowout port, and an air flow deflecting member that generates two air flows having different flow speeds as each other.

The flow path forming portion has a first wall and a second wall that face each other. In the air flow path, a space between the air flow deflecting member and the first wall is a first flow path, and a space between the air flow deflecting member and the second wall is a second flow path. The air flow deflecting member is configured so that an air flow having a higher speed than the air flow in the second flow path is generated in the first flow path and an air flow having a lower speed than the air flow in the first flow path is generated in the second flow path. Further, a part of the first wall on the side of the blowout port is a guide wall for guiding the high speed air flow to guide the high speed air flow from the first flow path along the wall surface, such that the direction of the high speed air flow is changed from heading toward the second wall to heading toward the first wall.

In this air discharge device, the high speed air flow is bent along the guide wall by the Coanda effect, and the low speed air flow is drawn into the high speed air current. Therefore, the bending angle when the air flowing through the air flow path is bent and blown out from the blowout port is increased.

### PRIOR ART LITERATURE

### Patent Literature

[Patent Document 1] JP 2014-210564 A

### SUMMARY OF INVENTION

However, as a result of detailed consideration by the inventors, the following issues were found in the above-described conventional air discharge device. The flow path forming portion has a third wall and a fourth wall connecting the first wall and the second wall. When the air flowing through the air flow path bends along the guide wall and is blown out from the blowout port, the air flow in the vicinity of the third wall flows along the third wall instead of the guide wall. Likewise, the air flow in the vicinity of the fourth wall flows along the fourth wall instead of the guide wall. Therefore, in the above-described conventional air discharge device, a part of the air flowing through the air flow path is blown out from the blowout port without being sufficiently bent.

It is an object of the present disclosure to provide a vehicle air conditioner capable of increasing the air flow along a guide wall as compared with a conventional air discharge device.

In the present disclosure,

an air discharge device that discharges air, includes

a blowout port that blows out air to a target space,

a flow path forming portion that forms therein an air flow path in communication with an air flow upstream side of the blowout port, and

an air flow deflecting member disposed in the air flow path, the air flow deflecting member configured to generate two air flows having different flow speeds in the air flow path, where

the flow path forming portion includes a first wall, a second wall that faces the first wall, a third wall disposed toward one end of the flow path forming portion in a predetermined direction that intersects a direction in which the first wall and the second wall face either, the third wall connecting the first wall with the second wall, and a fourth wall disposed toward an other end of the flow path forming portion in the predetermined direction, the fourth wall connecting the first wall with the second wall,

the air flow path includes a first flow path between the air flow deflecting member and the first wall and a second flow path between the air flow deflecting member and the second wall,

the air flow deflecting member is configured to set a cross-sectional area of the first flow path to be smaller than a cross-sectional area of the second flow path to generate a high speed air flow in the first flow path which has a higher flow speed than an air flow in the second flow path, and to generate a low speed air flow in the second flow path which has a lower flow speed than an air flow in the first flow path,

a part of the first wall on the side of the blowout port is shaped such that a distance between the first wall and the second wall increases along a direction toward an air flow downstream side, the part of the first wall forming a guide wall that guides the high speed air flow to bend the high speed air flow along a wall surface, such that the high speed air flow flows in a direction from the second wall toward the first wall, and

at least one of the third wall or the fourth wall includes a separation shape portion which, when the air flow deflecting member is in a state of minimizing the cross-sectional area of the first flow passage, is disposed on the air flow upstream side of a most downstream position of the air flow deflecting member which is at an air flow most downstream side, the separation shape portion being configured to cause an air flow on the air flow downstream side of the air flow deflecting member to separate from at least one of the third wall or the fourth wall.

In this air discharge device, at least one of the third wall or the fourth wall has a separation shape portion. Therefore, the air flow on the air flow downstream side of the air flow deflecting member is separated from at least one of the third wall or the fourth wall. Thus, according to this air discharge device, the amount of air flow along the guide wall can be increased as compared with a conventional air discharge device.

### BRIEF DESCRIPTION OF DRAWINGS

FIG. 1 is a cross-sectional view of an air discharge device of a first embodiment in a state of being mounted in a vehicle.

FIG. 2 is a plan view of a vehicle interior showing an arrangement of blowout ports in FIG. 1.

FIG. 3 is a schematic diagram showing a configuration of an air conditioning unit in FIG. 1.

FIG. 4 is an enlarged view of the air discharge device in FIG. 1.

FIG. 5 is a cross-sectional view of the air discharge device taken along line V-V in FIG. 4.

FIG. 6 is a cross-sectional view of an air discharge device corresponding to FIG. 4 in a face mode.

FIG. 7 is a cross-sectional view of an air discharge device corresponding to FIG. 4 in a defroster mode.

FIG. 8 is a cross-sectional view of an air discharge device corresponding to FIG. 5 in a concentration mode.

FIG. 9 is a view showing a wind speed distribution of blown air from a blowout port in a concentration mode of the air discharge device of the first embodiment.

FIG. 10 is a cross-sectional view of an air discharge device corresponding to FIG. 5 in a spread mode.

FIG. 11 is a view showing a wind speed distribution of blown air from a blowout port in a spread mode of the air discharge device of the first embodiment.

FIG. 12 is a cross-sectional view of an air discharge device of a Comparative Example 1.

FIG. 13 is a cross-sectional view of the air discharge device of Comparative Example 1 taken along line XIII-XIII in FIG. 12.

FIG. 14 is a cross-sectional view of the air discharge device of Comparative Example 1 taken along line XIV-XIV in FIG. 12.

FIG. 15 is a cross-sectional view of the air discharge device of a present embodiment corresponding to FIG. 5 in the face mode.

FIG. 16 is a cross-sectional view of the air discharge device of Comparative Example 1 in the concentration mode.

FIG. 17 is a view showing a wind speed distribution of blown air from a blowout port in a concentration mode of the air discharge device of the Comparative Example 1.

FIG. 18 is a cross-sectional view of the air discharge device of a second embodiment.

FIG. 19 is a cross-sectional view of the air discharge device of a third embodiment.

FIG. 20 is a cross-sectional view of the air discharge device of a fourth embodiment.

FIG. 21 is a cross-sectional view of the air discharge device of a fifth embodiment.

FIG. 22 is a cross-sectional view of the air discharge device of a sixth embodiment.

FIG. 23 is a cross-sectional view of the air discharge device of a seventh embodiment.

FIG. 24 is a cross-sectional view of the air discharge device of a eighth embodiment.

FIG. 25 is a cross-sectional view of an air discharge device of a ninth embodiment in the concentration mode.

FIG. 26 is a cross-sectional view of an air discharge device of a ninth embodiment in the spread mode.

FIG. 27 is a cross-sectional view of the air discharge device of a tenth embodiment.

FIG. 28 is a cross-sectional view of the air discharge device of a eleventh embodiment.

FIG. 29 is a cross-sectional view of the air discharge device of a twelfth embodiment.

FIG. 30 is a cross-sectional view of an air discharge device of a thirteenth embodiment in the concentration mode.

FIG. 31 is a cross-sectional view of an air discharge device of the thirteenth embodiment in the spread mode.

FIG. 32 is a cross-sectional view of an air discharge device of a fourteenth embodiment in the concentration mode.

FIG. 33 is a cross-sectional view of an air discharge device of the fourteenth embodiment in the spread mode.

### DETAILED DESCRIPTION

Hereinafter, embodiments of the present disclosure will be described with reference to the drawings. In the following embodiments, the same or equivalent parts are denoted by the same reference numerals as each other, and explanations will be provided to the same reference numerals. Arrows indicating up, down, front, rear, left, right, etc. in each drawing indicate respective directions in a vehicle mounted state.

### First Embodiment

In the present embodiment, an air discharge device according to the present disclosure is applied to a vehicle air conditioning unit mounted in the front region of a vehicle.

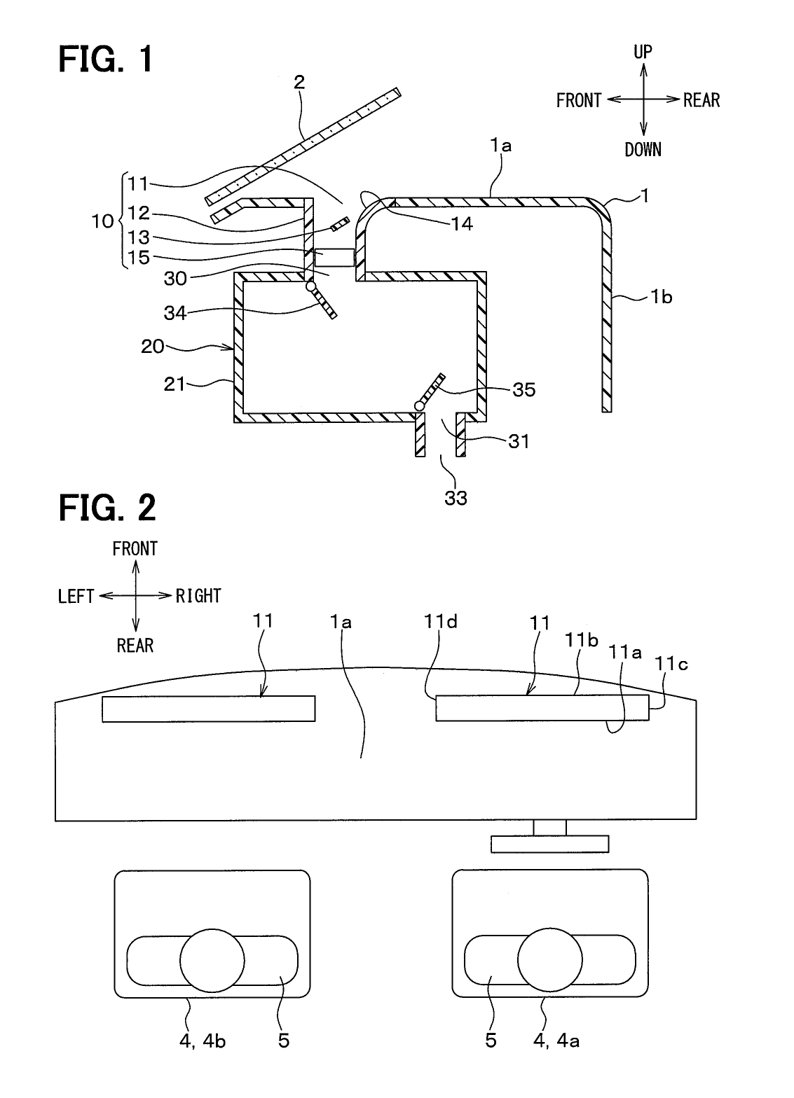

As shown in FIG. 1, the air discharge device 10 includes a blowout port 11, a duct 12, and an air flow deflecting door 13.

The blowout port 11 blows air into the interior space of the vehicle as a target space. The blowout port 11 is located on a windshield 2 side of an upper surface portion 1a of an instrument panel 1. In other words, when the windshield 2 is projected in parallel in the up-down direction with respect to the upper surface portion la, the blowout port 11 is positioned within a region of the upper surface portion 1a that overlaps with the windshield 2.

The instrument panel 1 is an instrument panel provided on the front side of the interior of the passenger compartment, and includes the upper surface portion 1a and a front surface portion lb. The front surface portion 1b is also referred to as a design surface portion. The instrument panel 1 refers not only to the portion where meters and gauges are arranged, but also to the entire panel located in front of the front seat in the passenger compartment, including a portion for housing audio and air conditioning. As shown in FIG. 2, the upper surface portion 1a is a portion of the instrument panel 1 which is visible when the instrument panel 1 is viewed from above.

The blowout port 11 switches a blowing mode between at least a defroster mode and a face mode with the air flow deflecting door 13, and blows out temperature adjusted air into the interior space of the vehicle. Here, in the defroster mode, the air is blown toward the windshield 2 to clear the fogging of the windows. In the face mode, air is blown towards the upper body of the front seat passengers.

The blowout port 11 is formed by an end portion of the duct 12 on the air flow downstream side. The duct 12 is a flow path forming portion that forms an air flow path in communication with an air flow upstream side of the blowout port 11, and The duct 12 is made of a resin which is formed separately from the upper surface portion 1a and an air conditioning unit 20. An end portion of the duct 12 on the air flow upstream side is connected to a defroster/face opening portion 30 of the air conditioning unit 20. Therefore, the duct 12 internally forms an air flow path through which the air sent from the air conditioning unit 20 flows. Alternatively, the duct 12 may be integrally formed with the air conditioning unit 20 instead.

The air flow deflecting door 13 is disposed inside the duct 12. The air conditioning unit 20 is disposed inside the instrument panel 1.

As shown in FIG. 2, the blowout port 11 is disposed at two locations: in front of a driver seat 4a and in front of a passenger seat 4b, in a right-hand drive vehicle. Hereinafter, the blowout port 11 in front of the driver seat 4a will be described, but the blowout port 11 arranged in front of the passenger seat 4b is also the same as the blowout port 11 in front of the driver seat 4a.

The blowout port 11 extends in a long and narrow fashion in the left-right direction. That is, the longitudinal direction of the opening shape of the blowout port 11 is along the left-right direction. The length of the blowout port 11 in the left-right direction is longer than the length of the seat 4 in the left-right direction. Alternatively, the length of the blowout port 11 in the left-right direction may be equal to or shorter than the length of the seat 4 in the left-right direction as well.

Specifically, the blowout port 11 is formed by opening edge portions 11a, 11b, 11c, 11d formed on the upper surface portion 1a of the instrument panel 1. The opening edge portions 11a, 11b, 11c, 11d include a pair of long sides 11a, 11b and a pair of short sides 11c, 11d on the surface of the upper surface portion 1a. The pair of long sides 11a, 11b are located on the rear side and the front side, respectively, and extend in the left-right direction. The long side 11a on the rear side is a rear edge portion 11a of the blowout port 11 and the long side 11b on the front side is a front edge portion 11b of the blowout port 11. The pair of short sides 11c, 11d connect the ends of the pair of long sides 11a, 11b to each other. In the present embodiment, the pair of long sides 11a and 11b have a linear shape, but the pair of long sides 11a and 11b may be curved instead as well.

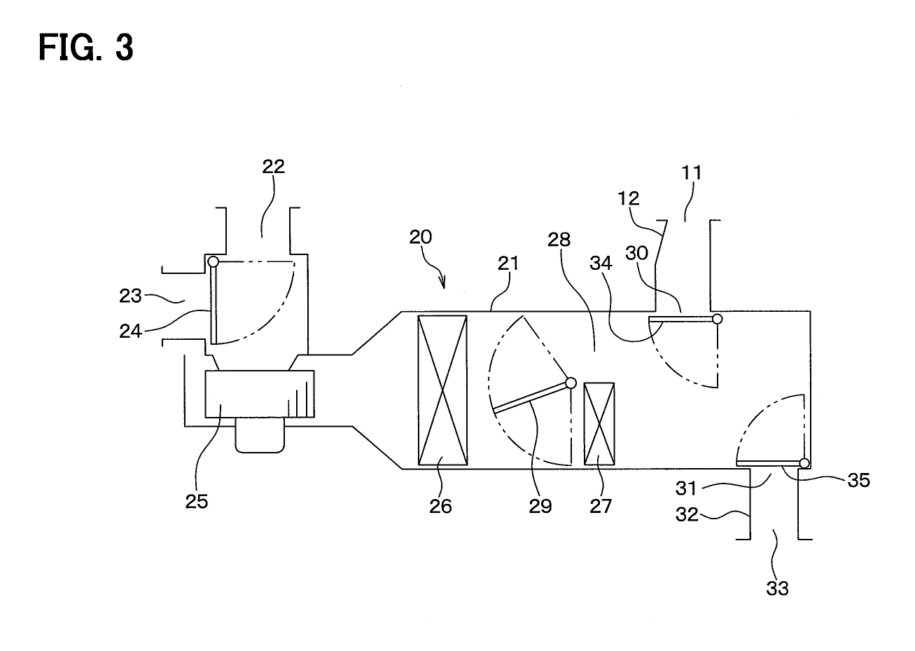

As shown in FIG. 3, the air conditioning unit 20 has an air conditioning casing 21 which forms an outer shell. The air conditioning casing 21 forms an air passage for guiding air into the passenger compartment which is an air conditioning target space. At the most upstream portion of the air conditioning casing 21 in the air flow direction, an inside air suction port 22 is formed for drawing in air in the passenger compartment (that is, inside air) and an outside air suction port 23 is formed for drawing in air outside the passenger compartment (that is, outside air). Further, a suction port opening and closing door 24 for selectively opening and closing the inside air suction port 22 and the outside air suction port 23 is provided in the air flow most upstream portion of the air conditioning casing 21. The inside air suction port 22, the outside air suction port 23, and the suction port opening and closing door 24 form an inside/outside air switching unit for switching the intake air into the air conditioning casing 21 between inside air and outside air. The operation of the suction port opening and closing door 24 is controlled by a control signal outputted from a controller (not shown).

A blower 25 that blows air into the passenger compartment is disposed on the air flow downstream side of the suction port opening and closing door 24. On the air flow downstream side of the blower 25, an evaporator 26 functioning as a cooler for cooling the air blown by the blower 25 is disposed. The evaporator 26 is a heat exchanger for exchanging heat between air and a refrigerant flowing therein, and forms a vapor compression type refrigeration cycle together with a compressor, a condenser, an expansion valve and the like, which are not illustrated.

On the air flow downstream side of the evaporator 26, a heater core 27 functioning as a heater for heating the air cooled by the evaporator 26 is disposed. The evaporator 26 and the heater core 27 together form a temperature adjustment unit for adjusting the temperature of the air blown into the passenger compartment.

Further, on the air flow downstream side of the evaporator 26, a cold air bypass passage 28 is formed to allow air which passed through the evaporator 26 to bypass the heater core 27. Here, the temperature of the conditioned air mixed on the air flow downstream side of the heater core 27 and the cold air bypass passage 28 varies depending on the air volume ratio of air passing through the heater core 27 and air passing through the cold air bypass passage 28. Therefore, an air mix door 29 is disposed on the air flow downstream side of the evaporator 26 at the entrance side of the heater core 27 and the cold air bypass passage 28. The air mix door 29 continuously changes the air volume ratio of cold air flowing into the heater core 27 and the cold air bypass passage 28. Accordingly, the air mix door 29 functions as a temperature adjusting unit together with the evaporator 26 and the heater core 27. The operation of the air mix door 29 is controlled by a control signal output from the controller.

A defroster/face opening portion 30 and a foot opening portion 31 are provided in the air flow most downstream portion of the air conditioning casing 21. The defroster/face opening portion 30 is connected to the blowout port 11 provided on the upper surface portion 1a of the instrument panel 1 via the duct 12. The foot opening portion 31 is connected to a foot blowout port 33 via a foot duct 32.

Further, a defroster/face door 34 that opens and closes the defroster/face opening portion 30 is disposed on the air flow upstream side of the defroster/face opening portion 30. A foot door 35 for opening and closing the foot opening portion 31 is disposed on the air flow upstream side of the foot opening portion 31. The defroster/face door 34 and the foot door 35 are blowout mode doors that switch the blowing state of the air blown into the passenger compartment.

The air flow deflecting door 13 operates in conjunction with these blowout mode doors 34, 35 to achieve a desired blowing mode. The operation of the air flow deflecting door 13 and the blowout mode doors 34, 35 is controlled by a control signal output from the controller. The air flow deflecting door 13 and the blowout mode doors 34, 35 are also capable of changing door positions in response to manual operation by a passenger.

For example, when the blowout mode being executed is a foot mode in which air is blown out from the foot blowout port 33 toward the feet of a passenger, the defroster/face door 34 closes the defroster/face opening portion 30 and the foot door 35 opens the foot opening portion 31. Conversely, when the blowout mode being executed is the defroster mode or face mode, the defroster/face door 34 opens the defroster/face opening portion 30 while the foot door 35 closes the foot opening portion 31. Further, in this case, the position of the air flow deflecting door 13 is set to a position corresponding to the desired blowout mode.

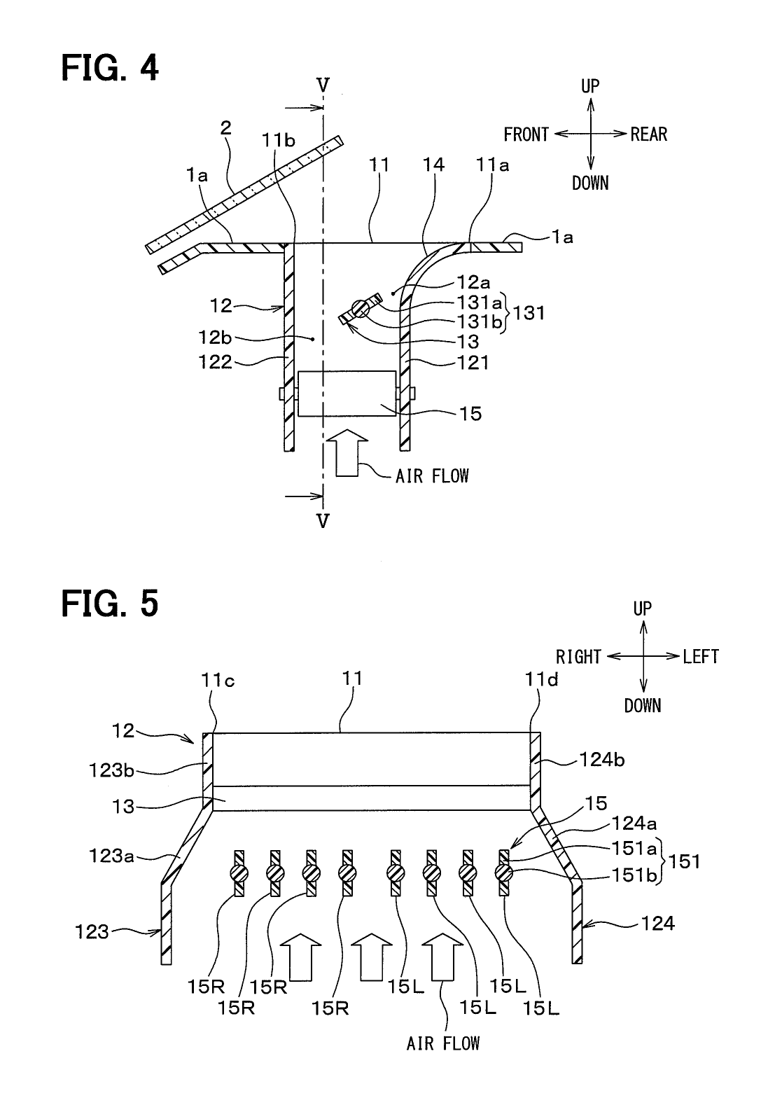

As shown in FIG. 4, the duct 12 includes a first wall 121 positioned on the rear side and a second wall 122 positioned on the front side. The first wall 121 and the second wall 122 face each other in the front-rear direction. Therefore, in the present embodiment, the front-rear direction corresponds to “the direction in which the first wall 121 and the second wall 122 face each other”. Further, the left-right direction corresponds to “a predetermined direction orthogonal to the direction in which the first wall 121 and the second wall 122 face each other.” In addition, a direction from the front to the rear corresponds to “the direction from the second wall 122 toward the first wall 121”.

The air flow downstream side end portion of the first wall 121 forms the rear long side 11a of the opening edge portion of the blowout port 11. The air flow downstream side end portion of the second wall 122 forms the front long side 11b of the opening edge portion of the blowout port 11.

Further, the portion of the first wall 121 on the side of the blowout port 11 forms a guide wall 14. The guide wall 14 is continuous with the upper surface portion 1a of the instrument panel 1. The guide wall 14 guides a high-speed air flow, which is described later, so that the high-speed air flow is bent along its wall surface by the Coanda effect, such that the direction of the high-speed air flow from the blowout port 11 is directed rearward. In other words, the guide wall 14 guides air flowing through the air flow path so as to blow out from the blowout port in a direction from the second wall 122 toward the first wall 121. The distance between the first wall 121 and the second wall 122 increases due to the guide wall 14 in a direction toward the air flow downstream side. In the present embodiment, the guide wall 14 is curved such that its wall surface is convex toward the inside of the duct 12. In other words, the guide wall 14 is curved such that the portion of the first wall 121 which is on the air flow upstream side of the portion of the first wall 121 on the side of the blowout port 11 is distanced away from the second wall 122 in a direction toward the air flow downstream side.

The air flow deflecting door 13 is an air flow deflecting member that deflects the air flow from the blowout port 11. Deflecting an air flow means changing the direction of air flow. The air flow deflecting door 13 generates two air flows having different flow speeds in the duct 12. Specifically, the air flow deflecting door 13 changes the speed of the air flow in each of a first flow path 12a and a second flow path 12b inside the duct 12. The first flow path 12a is formed between the air flow deflecting door 13 and the first wall 121 of the duct 12. The second flow path 12b is formed between the air flow deflecting door 13 and the second wall 122 of the duct 12.

In the present embodiment, a butterfly door 131 is used as the air flow deflecting door 13. The butterfly door 131 includes a plate-shaped door main body portion 131a and a rotating shaft 131b provided at the center portion of the door main body portion. The rotating shaft 131b extends in the left-right direction. Accordingly, the air flow deflecting door 13 rotates about its axis center with the direction along the left-right direction as the axial center direction. As the air flow deflecting door 13 rotates, the speeds of the air flow passing through the first flow path 12a and the air flow passing through the second flow path 12b are each changed. As a result, the direction of the air flow from the blowout port 11 changes.

As shown in FIG. 5, the duct 12 has a third wall 123 located on one end side the duct 12 in the left-right direction of and a fourth wall 124 located on the other end side of the duct 12 in the right-left direction. The third wall 123 is a wall that connects one end side of the first wall 121 to one end side of the second wall 122 among the walls forming the duct 12. The fourth wall 124 is a wall connecting the other end side of the first wall 121 to the other end side of the second wall 122 among the walls forming the duct 12. The third wall 123 and the fourth wall 124 face each other in the left-right direction. Accordingly, the third wall 123 and the fourth wall 124 face each other in a predetermined direction that intersects, or more specifically, orthogonal to a direction in which the first wall 121 and the second wall 122 face each other.

The air flow downstream side end portion of the third wall 123 constitutes the right short side 11c of the opening edge portion of the blowout port 11. The air flow downstream side end portion of the fourth wall 124 constitutes the left short side 11d of the opening edge portion of the blowout port 11.

The third wall 123 and the fourth wall 124 have reduction portions 123a and 124a in which the distance between the third wall 123 and the fourth wall 124 gradually decreases along a direction toward the air flow downstream side. The reduction portions 123a and 124a are separation shape portions for causing the air flow on the air flow downstream side of the air flow deflecting door 13 to separate from the third wall 123 and the fourth wall 124. The distance between the third wall 123 and the fourth wall 124 is the minimum distance between the third wall 123 and the fourth wall 124.

When the air flow deflecting door 13 is in a state that minimizes the cross-sectional area of the first flow path 12a, the reduction portion 123a is a portion of the third wall 123 which is located on the air flow upstream side of a most downstream position of the air flow deflecting door 13 which is located on the air flow most downstream side. Similarly, the reduction portion 124a is a portion of the fourth wall 124 which is located on the air flow upstream side of the most downstream position of the air flow deflecting door 13. In the present embodiment, when the door main body portion 131a of the air flow deflecting door 13 is in a state parallel to the horizontal direction, the air flow deflecting door 13 is in a state of minimizing the cross-sectional area of the first flow path 12a. The wall surfaces of the reduction portions 123a, 124a are flat surfaces.

A downstream side portion 123b of the third wall 123 and a downstream side portion 124b of the fourth wall 124 are shaped such that the distance between them is constant. The downstream side portions 123b, 124b are portions of the third wall 123 and the fourth wall 124 which are located on the air flow downstream side of the most downstream position of the air flow deflecting door 13. The distance between the downstream side portion 123b and the downstream side portion side 124b is the same as the minimum value of the distance between the reduction portion 123a and the reduction portion 124a.

The air discharge device 10 includes a plurality of adjustment members 15. The plurality of adjustment members 15 are disposed on the air flow upstream side of the air flow deflecting door 13 in the interior of the duct 12. The plurality of adjustment members 15 adjust the flow direction of air inside the duct 12 in the left and right direction, thereby adjusting the flow direction of air blown out from the blowout port 11 in the right and left direction.

The plurality of adjustment members 15 are arranged side by side in the left-right direction. One adjustment member 15 is plate shaped. In the present embodiment, a butterfly door 151 is used as the one adjustment member 15. The butterfly door 151 includes a plate-shaped door main body portion 151a and a rotating shaft 151b provided at a central portion of the door main body portion 151a. The rotating shaft 151b extends in the front-rear direction. Accordingly, the one adjustment member 15 rotates about its axis center in the front-rear direction as the axial center direction.

The plurality of adjustment members 15 include a plurality of first members 15R and a plurality of second members 15L. The plurality of first members 15R are a group of adjustment members 15 among the plurality of adjustment members 15 which are positioned on the third wall 123 side of a reference position. The plurality of second members 15L are a group of adjustment members 15 among the plurality of adjustment members 15 which are positioned on the fourth wall 124 side of the reference position. In the present embodiment, the reference position is the center position of the duct 12 in the left-right direction. The third wall 123 side is the right side. The fourth wall 124 side is the left side. In other words, the plurality of second members 15L are positioned on one side in the left-right direction with respect to the plurality of first members 15R. Each of the plurality of first members 15R and each of the plurality of second members 15L are oriented in predetermined directions to set the concentration mode, the spread mode, etc. as the wind direction mode of the air blown out from the blowout port 11.

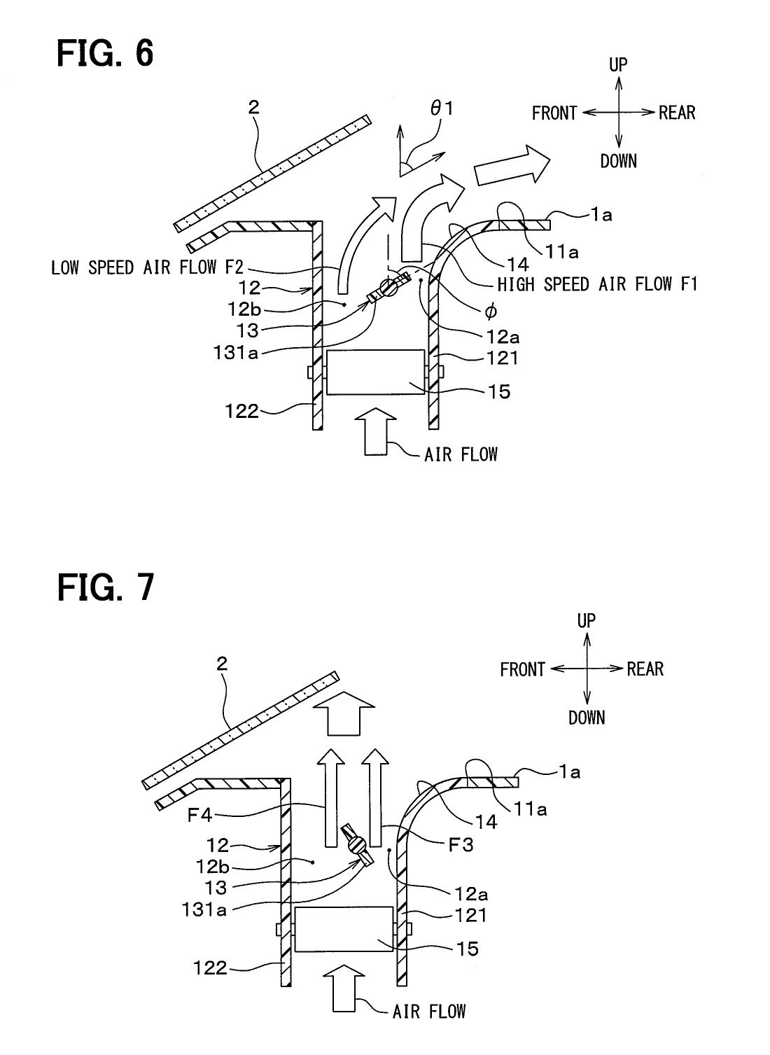

As shown in FIG. 6, when the blowout mode is the face mode, a door angle ϕ of the air flow deflecting door 13 is set to the angle shown in the drawing. That is, the door main body portion 131a of the air flow deflecting door 13 is inclined so that the distance between the door main body portion and the first wall 121 decreases along the air flow direction. As a result, the cross-sectional area of the first flow path 12a becomes smaller than the cross-sectional area of the second flow path 12b. A first state is set in which an air flow F1 having a higher speed than the air flow in the second flow path 12b is generated in the first flow path 12a and an air flow F2 having a lower speed than the air flow in the first flow path 12a is generated in the second flow path 12b. The cross-sectional area of the first flow path 12a means an area of a cross-section the first flow path 12a which the air flow crosses. The cross-sectional area of the second flow path 12b means an area of a cross-section the second flow path 12b which the air flow crosses.

In the first state, the high speed air flow F1 flows along the guide wall 14 due to the Coanda effect and is bent toward the rear side. At this time, a negative pressure is generated downstream of the air flow deflecting door 13 due to the flow of the high speed air flow F1. As a result, the low speed air flow F2 is drawn into the downstream side of the air flow deflecting door 13 and bent toward the high speed air flow F1 to merge with the high speed air flow F1. Due to this, a maximum bending angle θ1 when the air flowing inside the duct 12 is bent toward the rear side of the vehicle and blown out from the blowout port 11 is increased. As a result, the air whose temperature has been adjusted by the air conditioning unit 20, for example cold air, is blown out from the blowout port 11 toward the upper body of a passenger 5.

As shown in FIG. 7, when the blowing mode is the defroster mode, the door angle of the air flow deflecting door 13 is set to the angle shown in the drawing. That is, the door main body portion 131a of the air flow deflecting door 13 is inclined so that the distance between the door main body portion 131a and the second wall 122 decreases along the air flow direction. As a result, a second state is set in which air flows F3, F4 having the same speed or substantially the same speed are generated in the first flow path 12a and the second flow path 12b, respectively. In other words, the air flow speed in the first flow path 12a in the second state is a lower speed than in the first state. In the second state, each of the air flows F3, F4 flows upward. For this reason, air whose temperature has been adjusted by the air conditioning unit 20, such as warm air, is blown out from the blowout port 11 toward the windshield 2. Alternatively, when the blowout mode is the defroster mode, the door main body portion 131a may be parallel to the vertical direction instead.

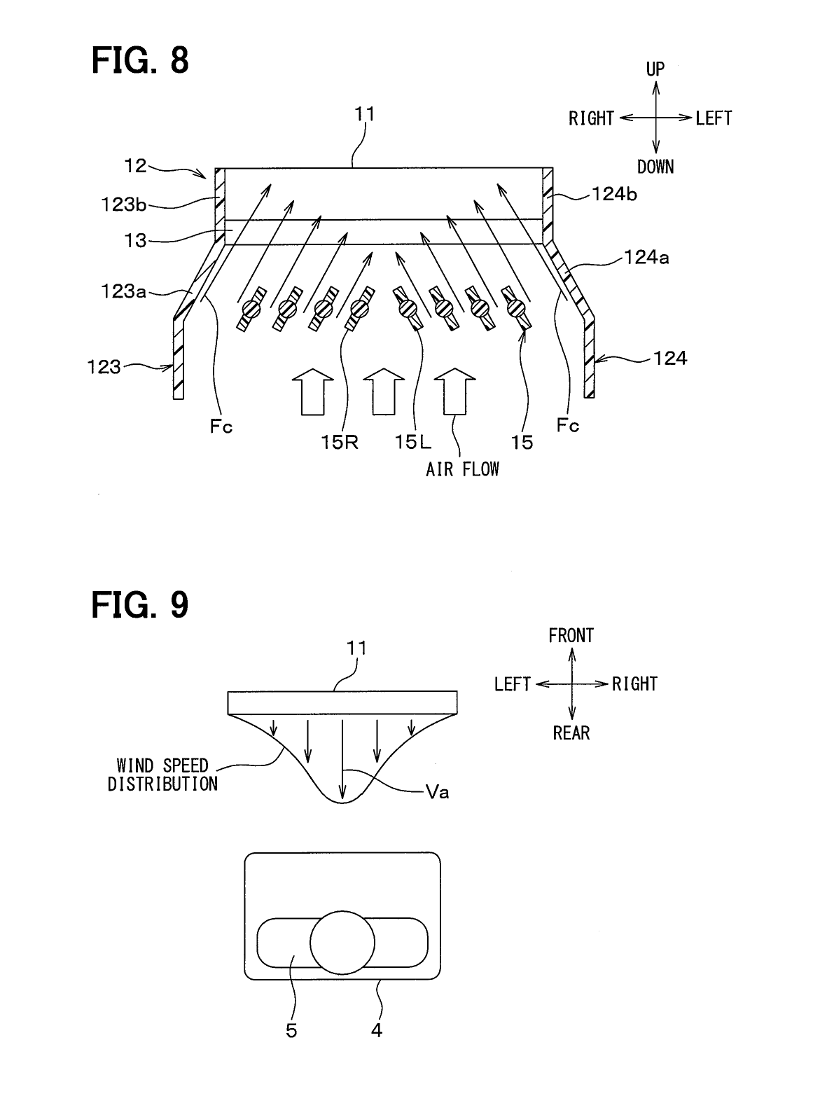

As shown in FIG. 8, when the wind direction mode is the concentration mode, the plurality of adjustment members 15 are oriented as shown in the drawing. In particular, the first members 15R and the second members 15L are inclined such the distance between the first members 15R and the second members 15L decreases along the air flowing direction. At this time, each of the first members 15R is tilted in the same direction. Further, each of the second members 15L is tilted in the same direction. The first members 15R is are tilted in a different direction as the second members 15L. As a result, the air flowing inside the duct 12 along the first member 15R and the second member 15L flows while converging. As a result, air is blown out from the blowout port 11 while being concentrated in the center region of the left-right direction.

When the concentration mode is executed during the face mode, the converging air flowing along the first members 15R and the second members 15L is bent along the guide wall 14 and is blown out from the blowout port 11 toward the rear side of the vehicle. As a result, the blown air from the blowout port 11 is concentrated on the passenger 5. In other words, as shown in FIG. 9, the wind speed distribution of the air blown from the blowout port 11 is a wind speed distribution where a maximum wind speed Va is at the center region of the blowout port 11 along the left-right direction.

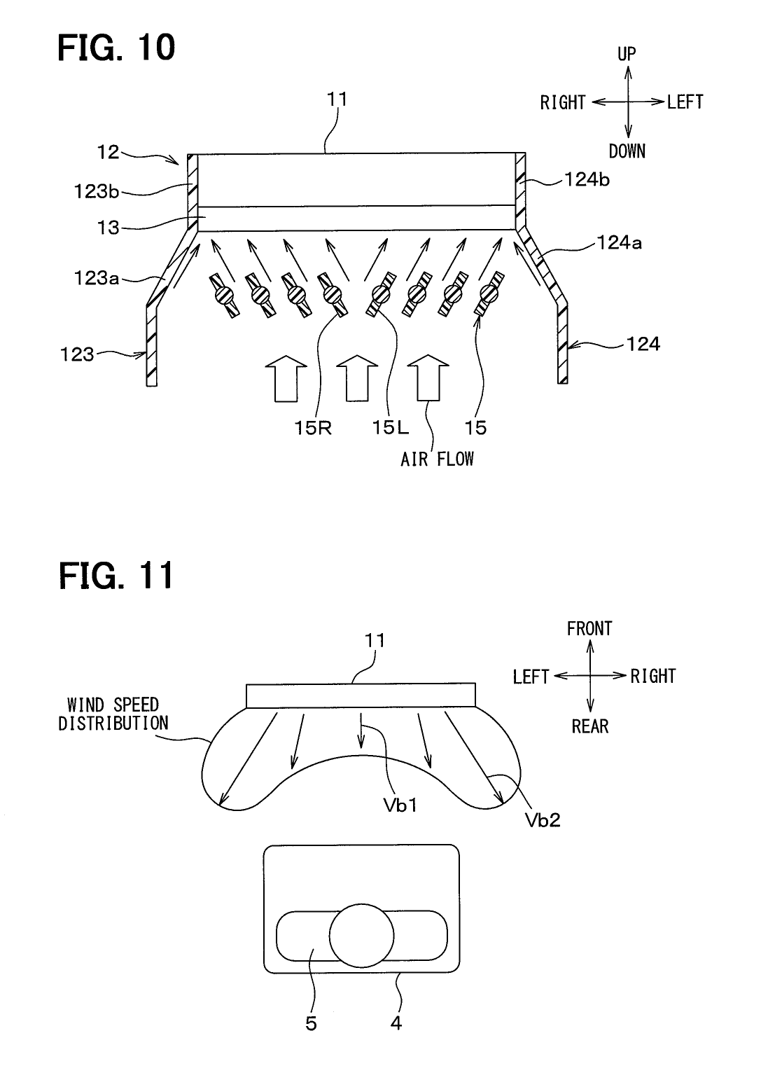

As shown in FIG. 10, when the wind direction mode is the spread mode, the plurality of adjustment members 15 are oriented as shown in the drawing. In particular, the first members 15R and the second members 15L are inclined such the distance between the first members 15R and the second members 15L increases along the air flowing direction. As a result, the air flowing inside the duct 12 along the first member 15R and the second member 15L flows while spreading out in the left-right direction. As a result, air is blown out from the blowout port 11 while spreading out in the left-right direction.

When the spread mode is executed during the face mode, the spreading air flowing along the first members 15R and the second members 15L is bent along the guide wall 14 and is blown out from the blowout port 11 toward the rear side of the vehicle. As a result, the blown air from the blowout port 11 flows to avoid the face of the passenger 5. In other words, as shown in FIG. 11, the wind speed distribution of the air blown from the blowout port 11 is a wind speed distribution where a wind speed Vb1 at the center region of the blowout port 11 in the left-right direction is minimized, while a wind speed Vb2 at both ends of the blowout port 11 in the left-right direction is maximized.

Next, the effects of the air discharge device 10 of the present embodiment will be described.

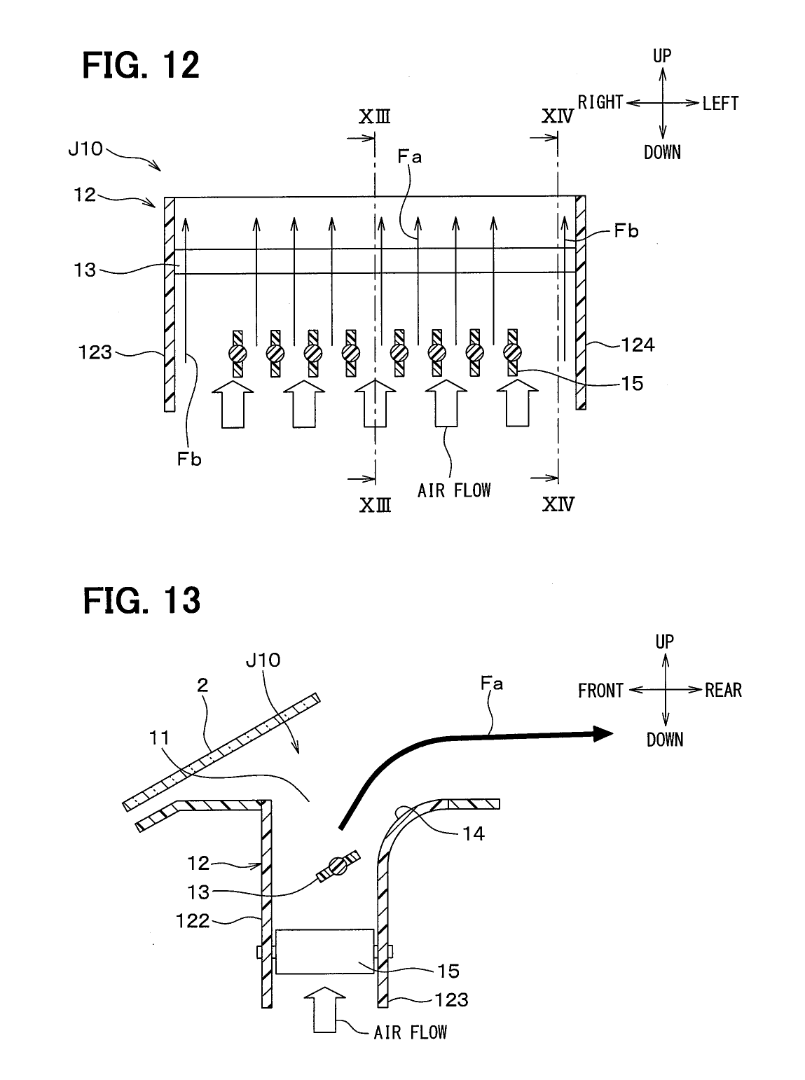

(1) The air discharge device 10 of the present embodiment and an air discharge device J10 of a Comparative Example 1 shown in FIG. 12 will be compared. In the air discharge device J10 of Comparative Example 1, the shapes of the third wall 123 and the fourth wall 124 are different from those of the air discharge device 10 of the present embodiment. In the air discharge device J10 of Comparative Example 1, the third wall 123 and the fourth wall 124 are arranged such that the distance between the third wall 123 and the fourth wall 124 is constant from the upstream side to the downstream side of the air flow deflecting door 13. The other configurations of the air discharge device J10 of Comparative Example 1 are the same as those of the air discharge device 10 of the present embodiment.

In the air discharge device J10 of Comparative Example 1, in the face mode, the air flow inside the duct 12 includes an air flow Fa which is spaced away from the third wall 123 and the fourth wall 124. As shown in FIG. 13, the air flow Fa bends along the guide wall 14.

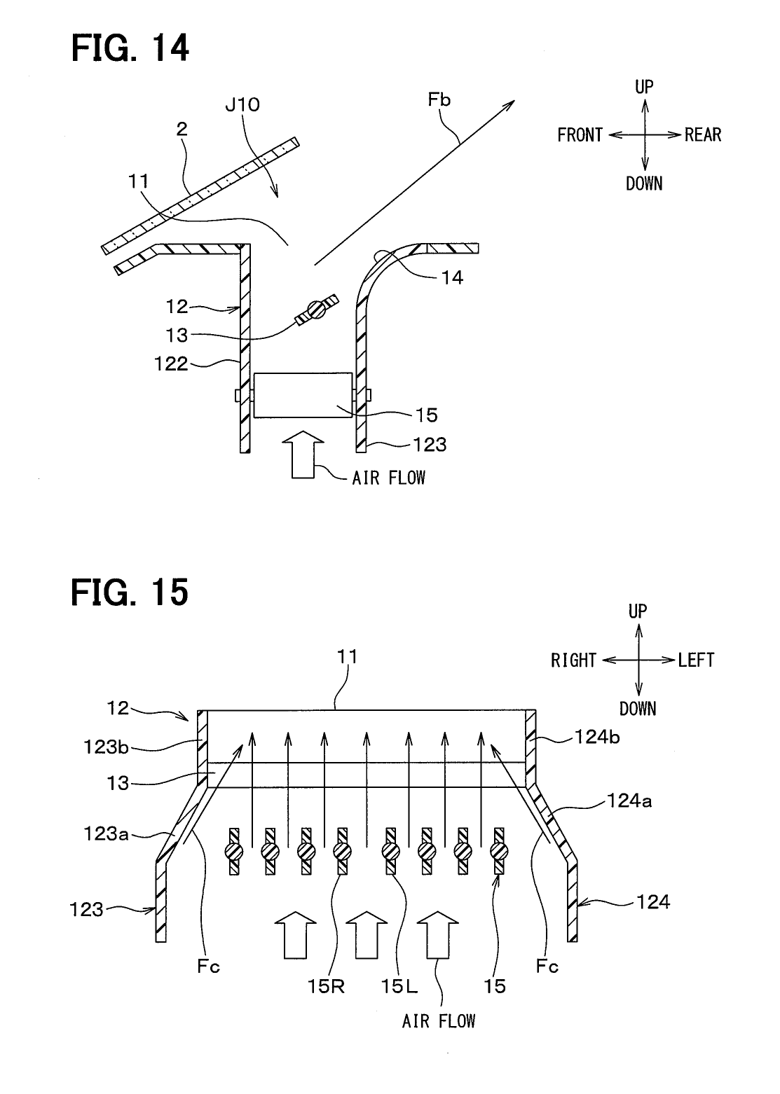

However, the air flow inside the duct 12 also includes an air flow Fb which is near the third wall 123 and the fourth wall 124. The air flow Fb flows along the third wall 123 and the fourth wall 124, and not the guide wall 14. For this reason, as shown in FIG. 14, the air flow Fb is blown out from the blowout port 11 without being sufficiently bent. That is, the air flow Fb does flow toward the passenger 5.

As described above, in the air discharge device J10 of Comparative Example 1, in the face mode, a portion Fb of the air flowing inside the duct 12 is blown out from the blowout port 11 without being sufficiently bent.

In contrast, in the air discharge device 10 of the present embodiment, as shown in FIG. 15, an air flow Fc near the reduction portions 123a, 124a flows along the reduction portions 123a, 124a. This air flow Fc flows toward the center region inside the duct 12 in the left-right direction. Accordingly, the air flow on the air flow downstream side of the air flow deflecting door 13 is separated from both the third wall 123 and the fourth wall 124.

As a result, in this air discharge device 10, the air flow along the guide wall 14 is increased as compared with the air discharge device J10 of Comparative Example 1. Therefore, according to the air discharge device 10, as compared with the air discharge device J10 of Comparative Example 1, the amount of air blown bent along the guide wall 14 and blown out from the blowout port 11 may be increased. In other words, according to the air discharge device 10, it is possible to increase the amount of air blown from the blowout port 11 toward the passenger 5.

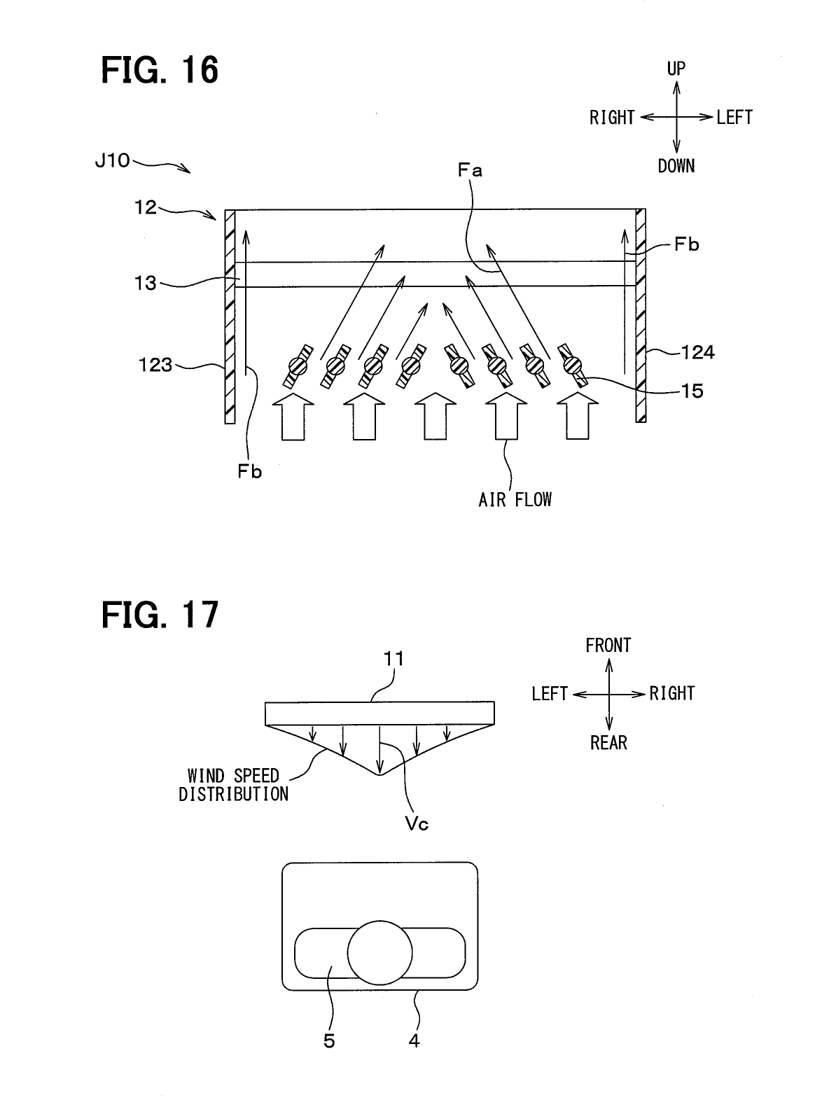

(2) As shown in FIG. 16, in the air discharge device J10 of Comparative Example 1, even in the concentration mode, similar to the case of the face mode, the air flow Fb in the vicinity of the third wall 123 and the fourth wall 124 flows along the third wall 123 and the fourth wall 124. For this reason, as shown in FIG. 14, the air flow Fb is blown out from the blowout port 11 without being sufficiently bent. That is, the air flow Fb does flow toward the passenger 5. As a result, as shown in FIG. 17, a problem arises in that among the air blown out from the blowout port 11, a wind speed Vc in the center region of the blowout port 11 in the left-right direction is not increased. That is, a problem arises in that the maximum wind speed Vc of the blown air reaching the passenger 5 may not satisfy a target wind speed.

In contrast, in the air discharge device 10 of the present embodiment, as shown in FIG. 8, in the concentration mode, the air flow Fc flowing along the reduction portions 123a, 124a, flows toward the center region inside the duct 12 in the left-right direction. Likewise, the air flowing along the plurality of adjustment members 15 also flows toward the center region inside the duct 12 in the left-right direction. In other words, the direction of the air flow Fc flowing along the reduction portions 123a, 124a is the same as or close to the direction of the air flow flowing along the plurality of adjustment members 15. Accordingly, in the air discharge device 10 of the present embodiment, as compared with the air discharge device J10 of Comparative Example 1, the amount of air blown out from the blowout port 11 is increased while being concentrated in the center region of the blowout port 11 in the left-right direction. Therefore, according to the air discharge device 10 of the present embodiment, as shown in FIG. 9, the wind speed Va of the blown air reaching the passenger 5 can be improved. That is, according to the air discharge device 10 of the present embodiment, it is possible to improve the maximum wind speed Va of the air blown from the blowout port 11 in the concentration mode.

### Second Embodiment

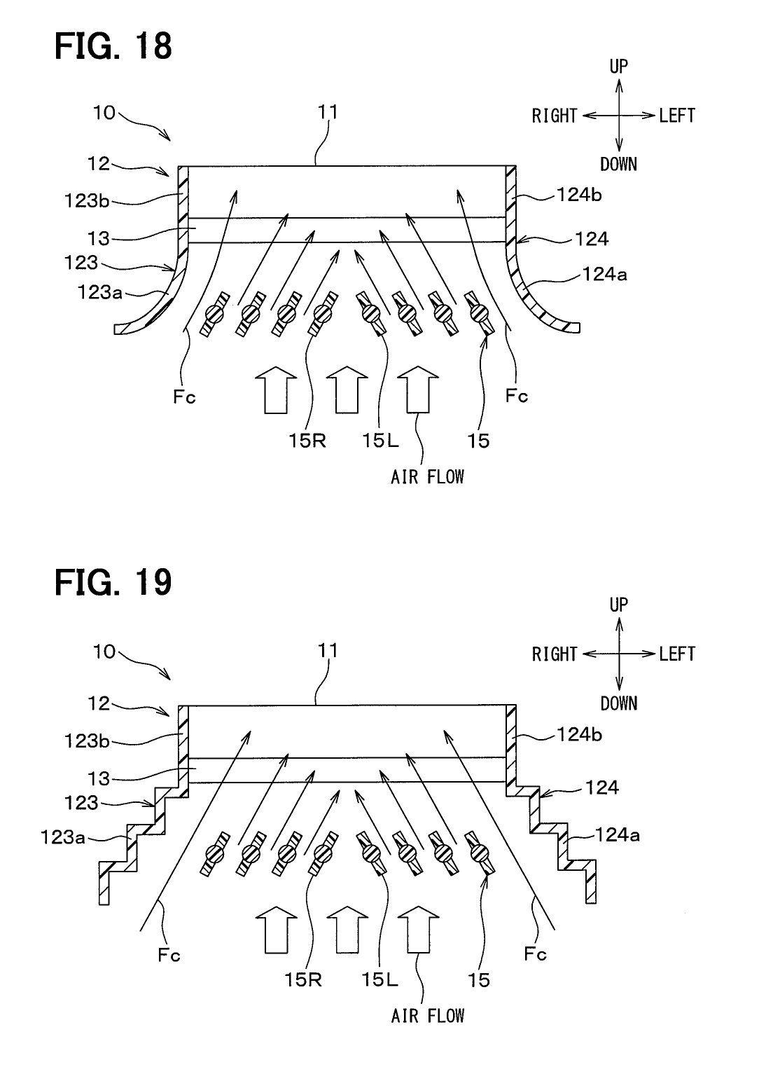

As shown in FIG. 18, in the air discharge device 10 of the present embodiment, each of the wall surfaces of the reduction portions 123a, 124a has a curved surface shape. The other configurations of the air discharge device 10 of the present embodiment are the same as those of the air discharge device 10 of the first embodiment.

In the air discharge device 10 of the present embodiment as well, the air flow Fc flowing along the reduction portions 123a, 124a flows toward the center region in the left-right direction inside the duct 12. Accordingly, the air discharge device 10 of the present embodiment also achieves the effects (1) and (2) described in the first embodiment.

### Third Embodiment

As shown in FIG. 19, in the air discharge device 10 of the present embodiment, each of the wall surfaces of the reduction portions 123a, 124a has a stepped shape. The other configurations of the air discharge device 10 of the present embodiment are the same as those of the air discharge device 10 of the first embodiment.

In the present embodiment, the reduction portions 123a, 124a are shaped such that the distance between the third wall 123 and the fourth wall 124 decreases in a stepped manner along a direction toward the air flow downstream side.

In the air discharge device 10 of the present embodiment as well, the air flow Fc flowing along the reduction portions 123a, 124a flows toward the center region in the left-right direction inside the duct 12. Accordingly, the air discharge device 10 of the present embodiment also achieves the effects (1) and (2) described in the first embodiment.

### Fourth Embodiment

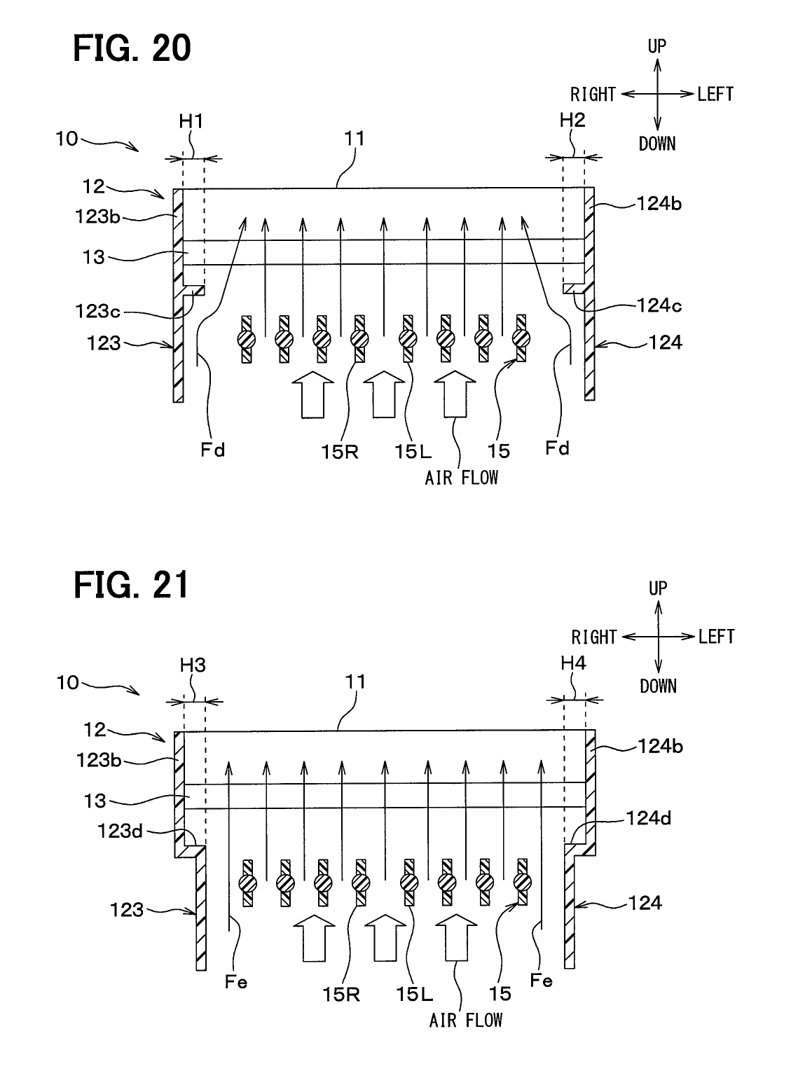

As shown in FIG. 20, the air discharge device 10 of the present embodiment is different from the air discharge device 10 of the first embodiment with respect to the separation shape portion of the third wall 123 and the fourth wall 124. The other configurations of the air discharge device 10 of the present embodiment are the same as those of the air discharge device 10 of the first embodiment.

The third wall 123 includes, as the separation shape portion, a protruding portion 123c which protrudes from the wall surface of the third wall 123. The protruding portion 123c is provided at a portion of the third wall 123 on the air flow upstream side of the most downstream position of the air flow deflecting door 13. Similarly, the fourth wall 124 includes a protruding portion 124c which protrudes from the wall surface of the fourth wall 124. The protruding portion 124c is provided at a portion of the fourth wall 124 on the air flow upstream side of the most downstream position of the air flow deflecting door 13.

A protrusion height H1 of the protruding portion 123c from the wall surface of the third wall 123 is the same as a protrusion height H2 of the protruding portion 124c from the wall face of the fourth wall 124.

In the air discharge device 10 of the present embodiment, the air flow Fd flowing in the vicinity of the third wall 123 and the fourth wall 124 on the air flow upstream side of the protruding portions 123c, 124c flows to avoid the protruding portions 123c, 124c. For this reason, the air flow Fd flowing in the vicinity of the third wall 123 and the fourth wall 124 flows toward the center region in the left-right direction inside the duct 12. Accordingly, the air discharge device 10 of the present embodiment also achieves the effects (1) and (2) described in the first embodiment.

### Fifth Embodiment

As shown in FIG. 21, the air discharge device 10 of the present embodiment is different from the air discharge device 10 of the first embodiment with respect to the separation shape portion of the third wall 123 and the fourth wall 124. The other configurations of the air discharge device 10 of the present embodiment are the same as those of the air discharge device 10 of the first embodiment.

The third wall 123 includes, as the separation shape portion, a stepped portion 123d which forms a level difference on the wall surface of the third wall 123. The stepped portion 123d is provided at a portion of the third wall 123 on the air flow upstream side of the most downstream position of the air flow deflecting door 13. Similarly, the fourth wall 124 has a stepped portion 124d which forms a level difference on the wall surface of the fourth wall 124. The stepped portion 124d is provided at a portion of the fourth wall 124 on the air flow upstream side of the most downstream position of the air flow deflecting door 13. A step size H3 of the stepped portion 123d is the same as a step size H4 of the stepped portion 124d.

The distance between the third wall 123 and the fourth wall 124 at the air flow downstream side of the stepped portions 123d, 124d is greater than the distance between the third wall 123 and the fourth wall 124 at the upstream side of the stepped portions 123d, 124d. Therefore, an air flow Fe flowing in the vicinity of the third wall 123 and the fourth wall 124 flows along the third wall 123 and the fourth wall 124 on the air flow upstream side of the stepped portions 123d, 124d, and then separates from the third wall 123 and the fourth wall 124.

In this regard, in the air discharge device 10 of the present embodiment as well, the air flow downstream of the air flow deflecting door 13 is separated from both the third wall 123 and the fourth wall 124. Accordingly, the air discharge device 10 of the present embodiment also achieves the effect (1) described in the first embodiment.

### Sixth Embodiment

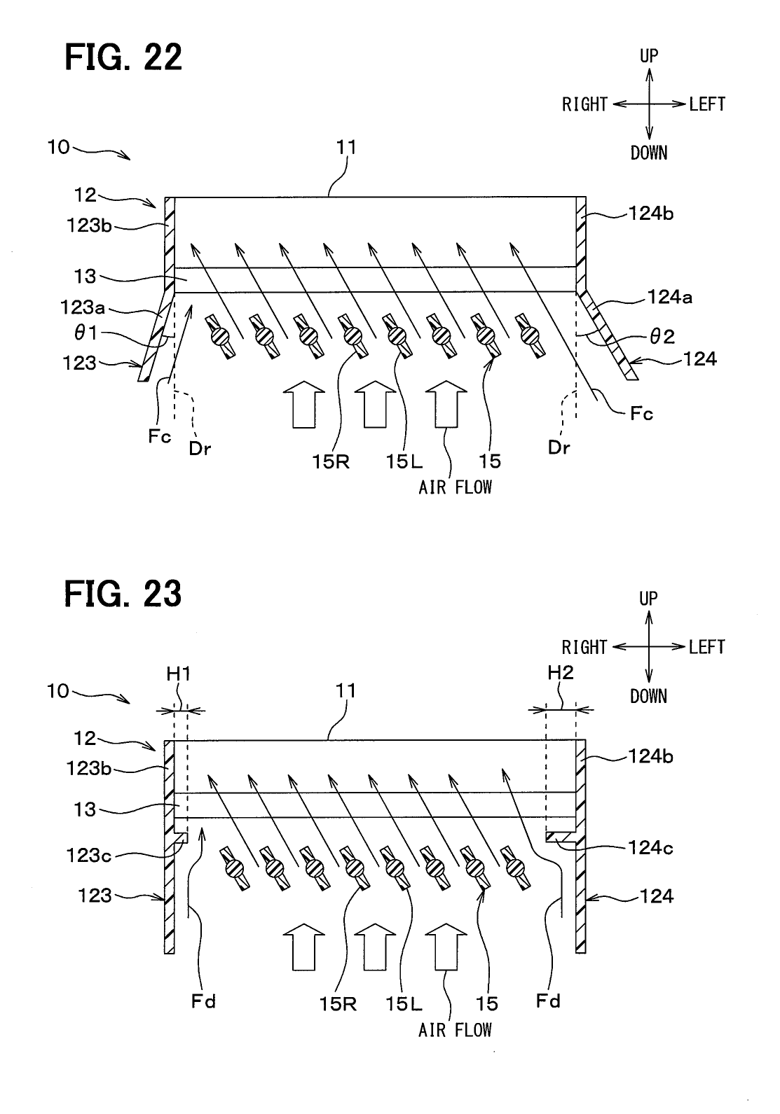

As shown in FIG. 22, in the air discharge device 10 of the present embodiment, an inclination θ1 of the reduction portion 123a is different from an inclination θ2 of the reduction portion 124a. The other configurations of the air discharge device 10 of the present embodiment are the same as those of the air discharge device 10 of the first embodiment.

The inclination θ1 of the reduction portion 123a is an angle formed by the wall surface of the reduction portion 123a with respect to a reference direction Dr. The inclination θ2 of the reduction portion 124a is an angle formed by the wall surface of the reduction portion 124a with respect to the reference direction Dr. The reference direction Dr is the vertical direction in the present embodiment.

According to the air discharge device 10 of the present embodiment as well, the same effects as the air discharge device 10 of the first embodiment can be obtained.

Here, there may be a case where a wind direction mode for directing the air blown from the blowout port 11 to one side in the left-right direction is performed. In this case, as shown in FIG. 22, the air flow inside the duct 12 may be directed to one side of the third wall 123 and the fourth wall 124 by the adjustment members 15. Therefore, for one of the third wall 123 or the fourth wall 124, it is unnecessary to proactively separate the air flow. In one of the third wall 123 or the fourth wall 124, the inclination of the reduction portion may be smaller as compared to the other one of the third wall 123 or the fourth wall 124.

Further, when the air blown from the air conditioning unit 20 flows into the duct 12 from the vehicle center side in the left-right direction of the vehicle, the air flowing through the duct 12 flows toward the wall surface on the side of the vehicle. Therefore, for one of the third wall 123 or the fourth wall 124 which is on the vehicle center side, it is unnecessary to proactively separate the air flow. In one of the third wall 123 or the fourth wall 124, the inclination of the reduction portion may be smaller as compared to the other one of the third wall 123 or the fourth wall 124.

In these cases, as in the air discharge device 10 of the present embodiment, it is preferable to set the inclination of the reduction portion 123a of the third wall 123 to be different from the inclination of the reduction portion 124a of the fourth wall 124.

In the present embodiment, the inclinations of the reduction portions 123a, 124a are different from each other, but alternatively, the shapes of the wall surfaces of the reduction portions 123a, 124a may be different as well. In this way, the size and/or shape of the reduction portions 123a, 124a may be different from each other. In other words, the sizes and shapes of the separation shape portions of the same type may be different.

### Seventh Embodiment

As shown in FIG. 23, in the air discharge device 10 of the present embodiment, the protrusion height H1 of the protruding portion 123c is different from the protrusion height H2 of the protruding portion 124c. The other configurations of the air discharge device 10 of the present embodiment are the same as those of the air discharge device 10 of the fourth embodiment.

According to the air discharge device 10 of the present embodiment as well, the same effects as the air discharge device 10 of the fourth embodiment can be obtained. Further, as described in the sixth embodiment, in the case where it is not necessary to proactively separate the air flow in one of the third wall 123 or the fourth wall 124, the configuration of the air discharge device 10 of the present embodiment can be used.

### Eighth Embodiment

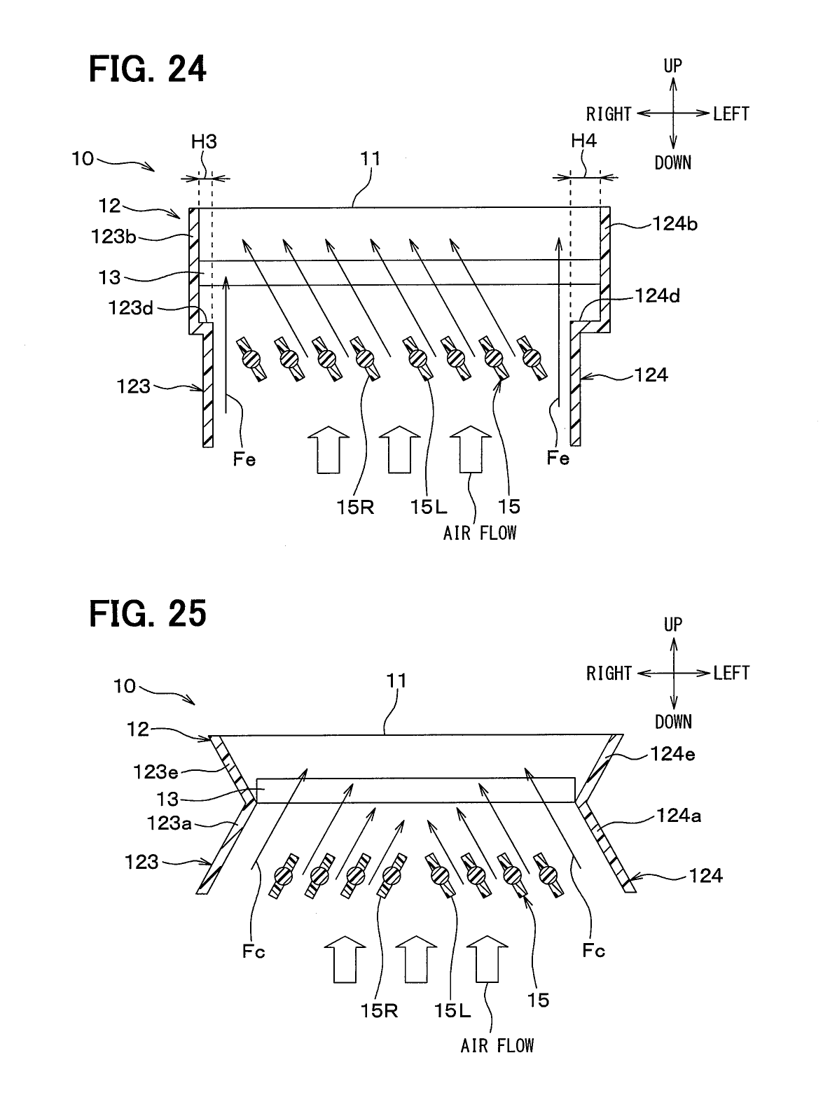

As shown in FIG. 24, in the air discharge device 10 of the present embodiment, the step size H3 of the stepped portion 123d is different from the step size H4 of the stepped portion 124d. The other configurations of the air discharge device 10 of the present embodiment are the same as those of the air discharge device 10 of the fifth embodiment.

According to the air discharge device 10 of the present embodiment as well, the same effects as the air discharge device 10 of the fifth embodiment can be obtained. Further, as described in the sixth embodiment, in the case where it is not necessary to proactively separate the air flow in one of the third wall 123 or the fourth wall 124, the configuration of the air discharge device 10 of the present embodiment can be used.

### Ninth Embodiment

As shown in FIG. 25, in the air discharge device 10 of the present embodiment, the third wall 123 and the fourth wall 124 include expansion portions 123e, 124e. The other configurations of the air discharge device 10 of the present embodiment are the same as those of the air discharge device 10 of the first embodiment.

In the expansion portions 123e and 124e, the distance between the third wall 123 and the fourth wall 124 gradually increases along a direction toward the air flow downstream side. The wall surfaces of the expansion portions 123e and 124e are flat surfaces. The expansion portion 123e is provided at a portion of the third wall 123 downstream of the reduction portion 123a in the air flow direction. The expansion portion 124e is provided at a portion of the fourth wall 124 downstream of the reduction portion 124a in the air flow direction.

As shown in FIG. 25, in the concentration mode, the air flow Fc in the vicinity of the reduction portions 123a, 124a flows along the reduction portions 123a, 124a. Accordingly, the air flow on the air flow downstream side of the air flow deflecting door 13 is separated from both the third wall 123 and the fourth wall 124. Thus, the air discharge device 10 of the present embodiment also achieves the effects (1) and (2) described in the first embodiment.

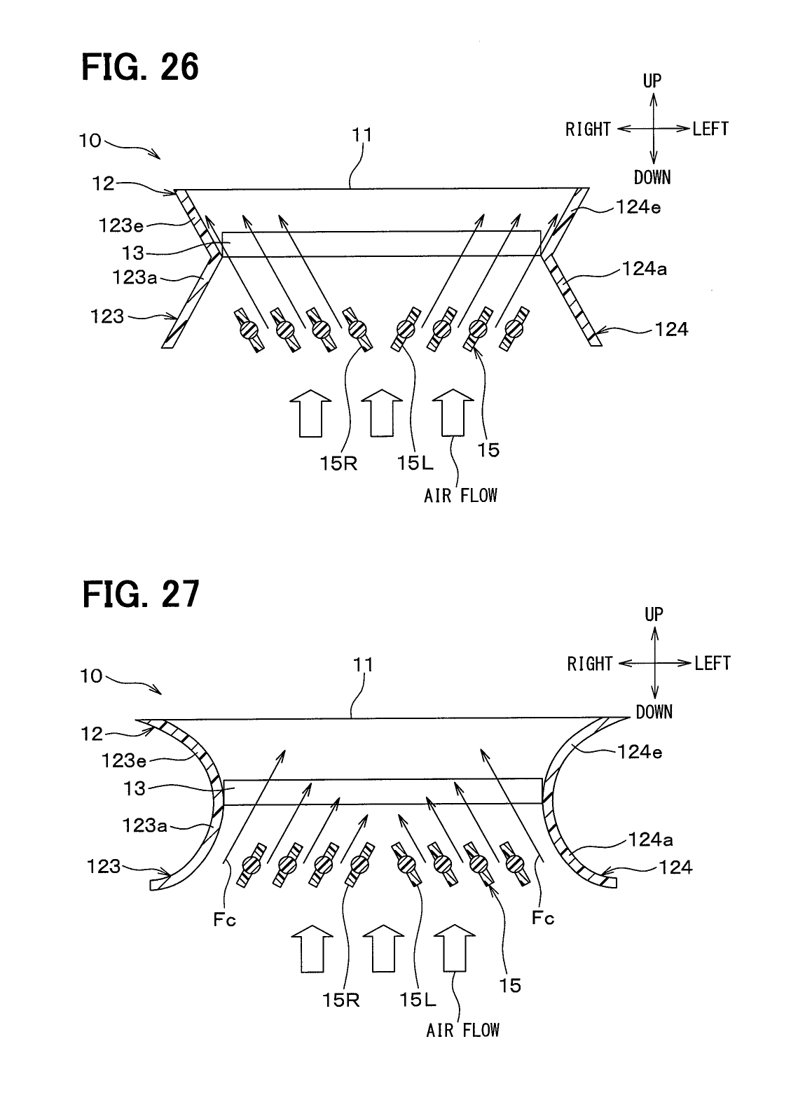

As shown in FIG. 26, in the spread mode, the air current flows along the expansion portions 123e and 124e. For this reason, the air blown from the blowout port 11 tends to spread out in the left-right direction. By executing this spread mode in the defroster mode, the air flow may spread throughout the entirety of the windshield 2. Therefore, the visibility performance of the windshield 2 may be improved.

### Tenth Embodiment

As shown in FIG. 27, in the air discharge device 10 of the present embodiment, the wall surfaces of the reduction portions 123a, 124a are curved surfaces, and the wall surfaces of the expansion portions 123e, 124e are curved surfaces. The other configurations of the air discharge device 10 of the present embodiment are the same as those of the air discharge device 10 of the ninth embodiment. According to the air discharge device 10 of the present embodiment as well, the same effects as the air discharge device 10 of the ninth embodiment can be obtained.

### Eleventh Embodiment

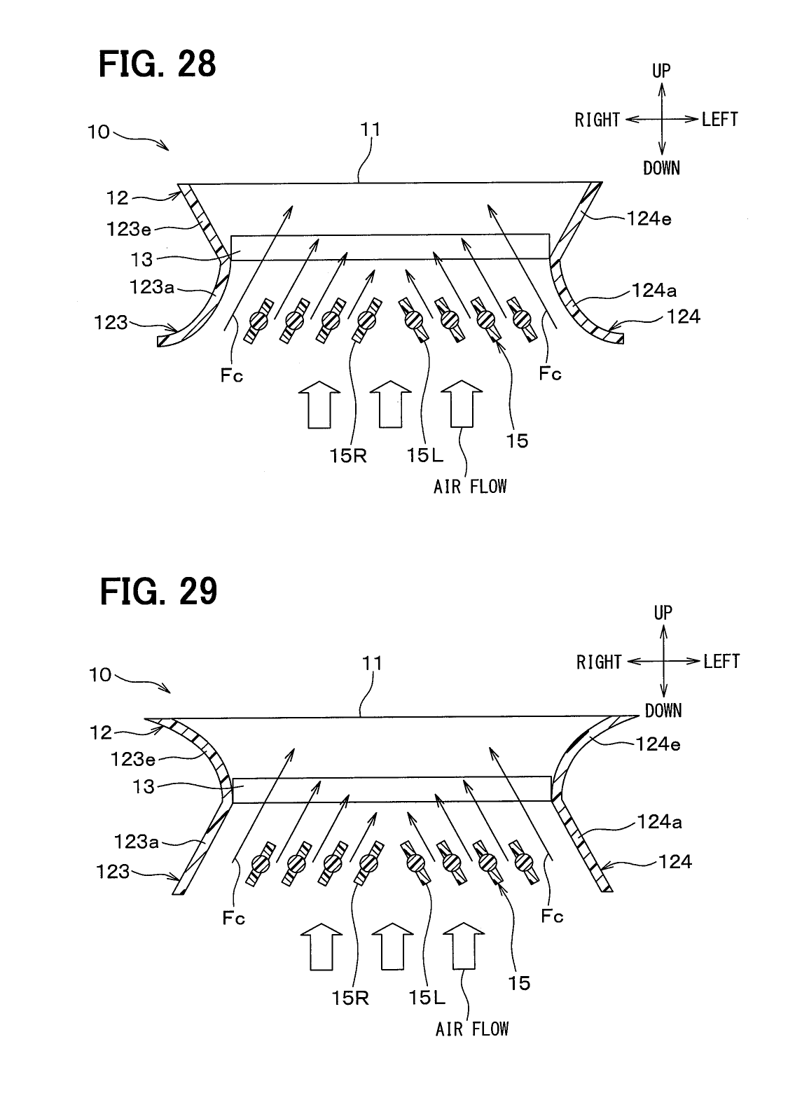

As shown in FIG. 28, in the air discharge device 10 of the present embodiment, the wall surfaces of the reduction portions 123a, 124a are curved surfaces, and the wall surfaces of the expansion portions 123e, 124e are flat surfaces. The other configurations of the air discharge device 10 of the present embodiment are the same as those of the air discharge device 10 of the ninth embodiment. According to the air discharge device 10 of the present embodiment as well, the same effects as the air discharge device 10 of the ninth embodiment can be obtained.

### Twelfth Embodiment

As shown in FIG. 29, in the air discharge device 10 of the present embodiment, the wall surfaces of the reduction portions 123a, 124a are flat surfaces, and the wall surfaces of the expansion portions 123e, 124e are curved surfaces. The other configurations of the air discharge device 10 of the present embodiment are the same as those of the air discharge device 10 of the ninth embodiment. According to the air discharge device 10 of the present embodiment as well, the same effects as the air discharge device 10 of the ninth embodiment can be obtained.

In addition, in the air discharge device 10 of the present embodiment, air flow tends to easily follow the expansion portions 123e and 124e in the spread mode as compared with the case where the wall surfaces of the expansion portions 123e and 124e are flat surfaces. For this reason, the air blown from the blowout port tends to more easily spread out in the left-right direction.

Furthermore, in the air discharge device 10 of the present embodiment, as compared with the case where the wall surfaces of the reduction portions 123a, 124a are curved surfaces, in the concentration mode, the air flow may more easily separate from the third wall 123 and the fourth wall 124.

### Thirteenth Embodiment

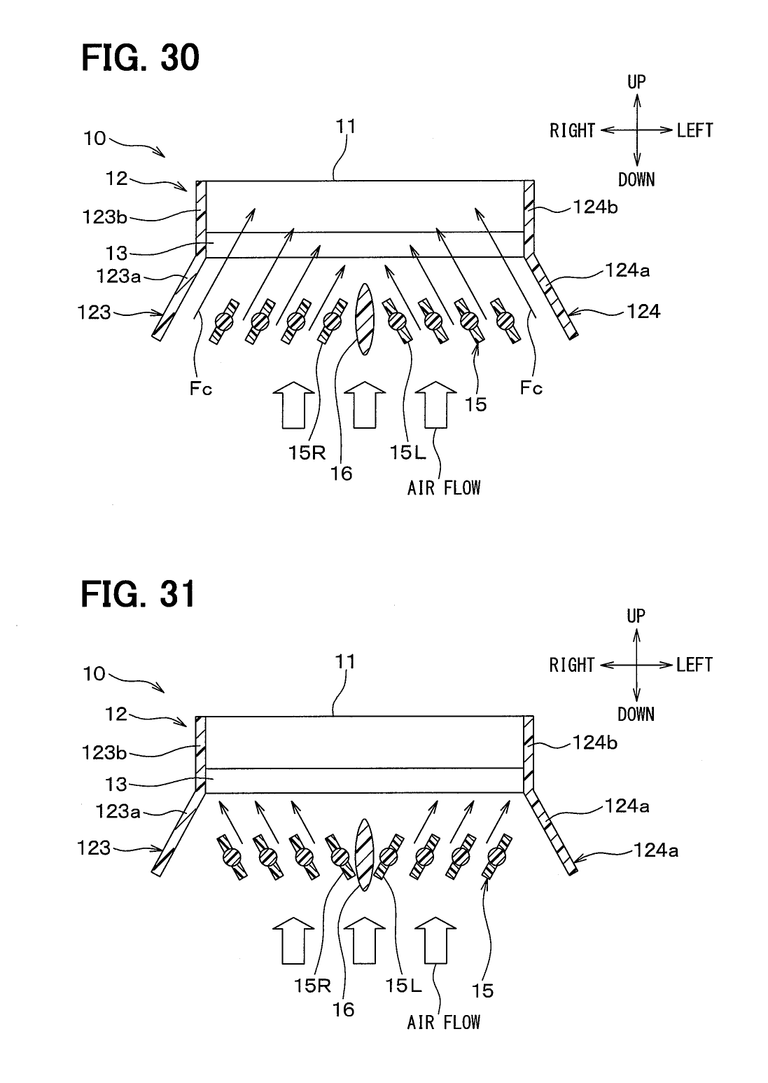

As shown in FIG. 30, the air discharge device 10 of the present embodiment is provided with a partition member 16. The other configurations of the air discharge device 10 of the present embodiment are the same as those of the air discharge device 10 of the first embodiment.

The partition member 16 is disposed between the plurality of first members 15R and the plurality of second members 15L inside of the duct 12. The partition member 16 has an elliptical cross-sectional shape in a cross-section parallel to the left-right direction and the up-down direction.

As shown in FIG. 30, in the concentration mode, the air flowing inside the duct 12 flows along the first members 15R and the second members 15L.

As shown in FIG. 31, in the spread mode, the air flowing inside the duct 12 flows along the first members 15R and the second members 15L. In the air discharge device 10 of the present embodiment, as compared with the case where the partition member 16 is not provided, the amount of air flowing straight between the plurality of first members 15R and the plurality of second members 15L is reduced. As a result, the air blown from the blowout port 11 tends to spread out in the left-right direction.

### Fourteenth Embodiment

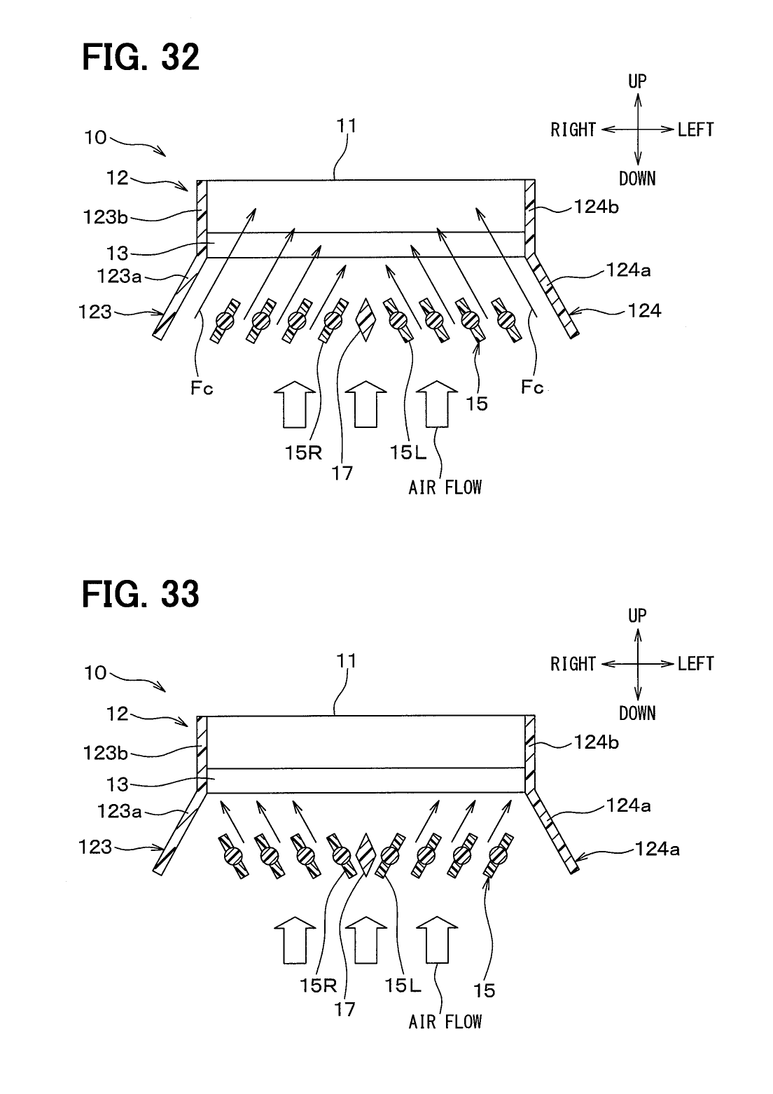

As shown in FIG. 32, the air discharge device 10 of the present embodiment is different from the air discharge device 10 of the thirteenth embodiment with respect to the shape of the partition member. The other configurations of the air discharge device 10 of the present embodiment are the same as those of the air discharge device 10 of the thirteenth embodiment.

The air discharge device 10 of the present embodiment is provided with a partition member 17. The partition member 17 has the same function as the partition member 16 described in the thirteenth embodiment. The cross-sectional shape of the partition member 17 in the cross-section parallel to the left-right direction and the up-down direction is a quadrangle in which corner portions are arranged on the upstream side and the downstream side in the air flow direction.

As shown in FIG. 32, in the concentration mode, the air flowing inside the duct 12 flows along the first members 15R and the second members 15L.

As shown in FIG. 33, in the spread mode, the air flowing inside the duct 12 flows along the first members 15R and the second members 15L. According to the air discharge device 10 of the present embodiment as well, the same effects as in the thirteenth embodiment can be obtained.

### Other Embodiments

(1) In each of the above-described embodiments, the third wall 123 and the fourth wall 124 have the same type of separation shape portion, but this is not limiting. The third wall 123 and the fourth wall 124 may have different kinds of separation shape portions. For example, the third wall 123 may have the reduction portion 123a, and the fourth wall 124 may have the protruding portion 124c.

(2) In each of the above embodiments, both the third wall 123 and the fourth wall 124 have separation shape portion, but this is not limiting. Instead, only one of the third wall 123 or the fourth wall 124 may have a separation shape portion instead.

(3) In each of the above-described embodiments, the two blowout ports 11 are disposed in front of the driver seat 4a and in front of the front passenger seat 4b, respectively, but these two blowout ports 11 may be connected to each other to form one blowout port instead. Further alternatively, one blowout port 11 may be disposed at a center portion of the upper surface portion 1a of the instrument panel 1 along the left-right direction of the vehicle, rather than in front of either the driver seat 4a or the passenger seat 4b.

(4) In each of the above-described embodiments, the guide wall 14 has a shape in which its wall surface is curved convexly toward the inside of the duct 12, but this is not limiting. The shape of the guide wall 14 may be any shape as long as it guides the air flow inside the duct 12 so as to bend toward the vehicle rear direction along its wall surface by the Coanda effect, thereby blowing air toward the rear of the vehicle from the blowout port 11. Specifically, the shape of the guide wall 14 may be any shape as long as the distance between the first wall 121 and the second wall 122 increases along a direction toward the air flow downstream side. Such a guide wall 14 may, for example, have a wall surface with a flat surface shape, such that the distance in the vehicle front-rear direction between the first wall 121 and the second wall 122 gradually increases in a direction toward the air flow downstream side. Further alternatively, the shape of the guide wall 14 may, for example, be a stepped shape with a stepped portion on its wall surface, such that the distance in the vehicle front-rear direction between the first wall 121 and the second wall 122 increases stepwise in a direction toward the air flow downstream side. Here, a curved shape means a gently curved surface shape with no corner on its surface. A stepped shape means a shape in which a flat surface is bend and has corners.

(5) In each of the above embodiments, a butterfly door is used as the air flow deflecting door 13. However, another door such as a sliding door may be used instead. In the case of using a sliding door, the position of the air flow deflecting door 13 is set to a position where the cross-sectional area of the first flow path 12a is smaller than the cross-sectional area of the second flow path 12b. As a result, a high speed air flow is generated in the first flow path 12a, while a low speed air flow is generated in the second flow path 12b. In this case as well, the position of the separation shape portion such as the reduction portion or the protruding portion is, when the sliding door is in a state of minimizing the cross-sectional area of the first flow path 12a, a position which is on the air flow upstream side of a most downstream position of the sliding door which is located on the air flow most downstream side.

(6) In each of the above-described embodiments, the plurality of adjustment members 15 include the plurality of first members 15R and the plurality of second members 15L, but this is not limiting. The number of the first members 15R included in the plurality of adjustment members 15 may be one. Similarly, the number of the second members 15L included in the plurality of adjustment members 15 may be one.

The present disclosure is not limited to the foregoing description of the embodiments and can be modified within the scope of the present disclosure. The present disclosure may also be varied in many ways. Such variations are not to be regarded as departure from the disclosure, and all such modifications are intended to be included within the scope of the disclosure. Individual elements or features of a particular embodiment are generally not limited to that particular embodiment, but, where applicable, are interchangeable and can be used in a selected embodiment, even if not specifically shown or described. Individual elements or features of a particular embodiment are not necessarily essential unless it is specifically stated that the elements or the features are essential in the foregoing description, or unless the elements or the features are obviously essential in principle. A quantity, a value, an amount, a range, or the like, if specified in the above-described example embodiments, is not necessarily limited to the specific value, amount, range, or the like unless it is specifically stated that the value, amount, range, or the like is necessarily the specific value, amount, range, or the like, or unless the value, amount, range, or the like is obviously necessary to be the specific value, amount, range, or the like in principle. Furthermore, a material, a shape, a positional relationship, or the like, if specified in the above-described example embodiments, is not necessarily limited to the specific material, shape, positional relationship, or the like unless it is specifically stated that the material, shape, positional relationship, or the like is necessarily the specific material, shape, positional relationship, or the like, or unless the material, shape, positional relationship, or the like is obviously necessary to be the specific material, shape, positional relationship, or the like in principle.

### CONCLUSION

According to a first aspect shown in part or all of the above embodiments, an air discharge device includes a blowout port, a flow path forming portion, and an air flow deflecting member. The flow path forming portion includes a first wall, a second wall, a third wall, and a fourth wall. The air flow deflecting member generates a high speed air flow in the first flow path and low speed air flow in the second flow path. A part of the first wall on the side of the blowout port forms a guide wall for guiding a high speed air flow. At least one of the third wall or the fourth wall includes a separation shape portion that causes the air flow on the air flow downstream side of the air flow deflecting member to separate from at least one of the third wall or the fourth wall.

Further, according to a second aspect, the separation shape portion is a reduction portion in which the distance between the third wall and the fourth wall decreases along a direction toward the air flow downstream side. As a specific structure of the separation shape portion, a reduction portion can be used.

Further, according to a third aspect, the separation shape portion is a protruding portion which protrudes from at least one wall surface of the third wall or the fourth wall. As a specific structure of the separation shape portion, a protruding portion can be used.

Further, according to a fourth aspect, the air discharge device further includes a plurality of plate-shaped adjustment members provided in the air flow path which adjust the direction of the air flow. Each of the plurality of adjustment members is disposed on the air flow upstream side of the air flow deflecting member and is arranged side by side along a predetermined direction. The plurality of adjustment members include one or more first members, and one or more second members positioned toward one side in a predetermined direction with respect to the first members. Each of the first members and the second members is inclined such the distance between the first members and the second members decreases along the air flow direction.

Accordingly, it is possible to perform a concentration mode in which the air blown from the blowout port is concentrated in one area. In the concentration mode, the wind speed at the concentrated portion of the blown air is the maximum wind speed.

Here, in the case where the third wall and the fourth wall have no separation shape portion, the air flow in the vicinity of the third wall and the fourth wall flows along the third wall and the fourth wall. For this reason, a part of the air flowing through the air flow path is blown out from the blowout port without being sufficiently bent. As a result, there arises a problem in that the maximum wind speed of the blown air does not increase in the concentration mode.

In this regard, when the reduction portion or the protruding portion is adopted as the separation shape portion, the direction of the air flow flowing along the separation shape portion can be brought closer to the direction of the air flow flowing along the plurality of adjustment members. Therefore, according to the air discharge device of the second aspect and the third aspect, the maximum wind speed of the air blown from the blowout port in the concentration mode can be improved.

Further, according to a fifth aspect, the separation shape portion is a stepped portion in which a step is formed on the wall surface. The distance between the third wall and the fourth wall at the air flow downstream side of the stepped portion is greater than the distance between the third wall and the fourth wall at the upstream side of the stepped portion. As a specific structure of the separation shape portion, the stepped portion can be used.

Further, according to a sixth aspect, both the third wall and the fourth wall includes a separation shape portion. The separation shape portion of the third wall and the separation shape portion of the fourth wall are different from each other. In this regard, the separation shape portion of the third wall and the separation shape portion of the fourth wall may be different from each other.

What is claimed is:

1. An air discharge device that discharges air, comprising:
a blowout port that blows out air to a target space;
a flow path forming portion that forms therein an air flow path in communication with an air flow upstream side of the blowout port; and
an air flow deflecting member disposed in the air flow path, the air flow deflecting member configured to generate two air flows having different flow speeds in the air flow path, wherein
the flow path forming portion includes
a first wall,
a second wall that faces the first wall,
a third wall disposed toward one end of the flow path forming portion in a predetermined direction that intersects a direction in which the first wall and the second wall face either, the third wall connecting the first wall with the second wall, and
a fourth wall disposed toward an other end of the flow path forming portion in the predetermined direction, the fourth wall connecting the first wall with the second wall,
the air flow path includes a first flow path between the air flow deflecting member and the first wall and a second flow path between the air flow deflecting member and the second wall,
the air flow deflecting member is configured to set a cross-sectional area of the first flow path to be smaller than a cross-sectional area of the second flow path to generate a high speed air flow in the first flow path which has a higher flow speed than an air flow in the second flow path, and to generate a low speed air flow in the second flow path which has a lower flow speed than an air flow in the first flow path,
a part of the first wall on the side of the blowout port is shaped such that a distance between the first wall and the second wall increases along a direction toward an air flow downstream side, the part of the first wall forming a guide wall that guides the high speed air flow to bend the high speed air flow along a wall surface, such that the high speed air flow flows in a direction from the second wall toward the first wall, and
at least one of the third wall or the fourth wall includes a separation shape portion which, when the air flow deflecting member is in a state of minimizing the cross-sectional area of the first flow passage, is disposed on the air flow upstream side of a most downstream position of the air flow deflecting member which is at an air flow most downstream side, the separation shape portion being configured to cause an air flow on the air flow downstream side of the air flow deflecting member to separate from at least one of the third wall or the fourth wall.

2. The air discharge device according to claim 1, wherein the separation shape portion is a reduction portion in which the distance between the third wall and the fourth wall decreases along a direction toward the air flow downstream side.

3. The air discharge device according to claim 1, wherein the separation shape portion is a protruding portion which protrudes from at least a wall surface of the third wall or the fourth wall.

4. The air discharge device according to claim 2, further comprising:
a plurality of plate-shaped adjustment members disposed in the air flow path, the adjustment members configured to adjust an air flow direction, wherein
the plurality of adjustment members are disposed on the air flow upstream side of the air flow deflecting member and are arranged side by side along the predetermined direction.
the plurality of adjustment members include one or more first members, and one or more second members positioned toward one side in the predetermined direction with respect to the first members, and
the first members and the second members are inclined such that a distance between the first members and the second members decreases along the air flow direction.

5. The air discharge device of claim 1, wherein
the separation shape portion is a stepped portion in which a level difference is formed on a wall surface, and
the distance between the third wall and the fourth wall at the air flow downstream side of the stepped portion is greater than the distance between the third wall and the fourth wall at the air flow upstream side of the stepped portion.

6. The air discharge device according to claim 1, wherein
both the third wall and the fourth wall include the separation shape portion, and
the separation shape portion of the third wall and the separation shape portion of the fourth wall are different from each other.
